(19) United States
(12) Patent Application Publication
(10) Pub. No.: US 2026/0005830 A1
(43) Pub. Date: Jan. 1, 2026

(54) Parallelizing Computations of Neural Activations and Layer Normalizations in FHE Environments of Deep Learning Models

(71) Applicant: International Business Machines Corporation, Armonk, NY (US)

(72) Inventors: Itamar Zimerman, Tel Aviv (IL); Nir Drucker, Zichron Yaakov (IL)

(21) Appl. No.: 18/760,219

(22) Filed: Jul. 1, 2024

(51) Int. Cl. H04L 9/00; G06N 3/045; G06N 3/0464; G06N 3/08

(52) U.S. Cl. CPC H04L 9/008; G06N 3/045; G06N 3/0464; G06N 3/08

(57) ABSTRACT

Parallelizing functions in deep learning models within homomorphic encryption environments is provided. The method comprises arranging layers in a deep learning model architecture. The layers comprise a first layer computed using a sign function and a second layer having components that can be pre-computed or ignored once computing the sign function on the second layer, wherein the first layer and second layer are adjacent within the deep learning model architecture. The deep learning model architecture is trained with a number of hyper-parameters, and the trained deep learning model architecture is run under homomorphic encryption.

### BACKGROUND

The disclosure relates generally to homomorphic encryption and more specifically to application of homomorphic encryption to deep learning models.

Homomorphic encryption (HE) is a form of encryption in which computations can be performed on encrypted data without the need to first decrypt the data. The encrypted data is in the form of a ciphertext that contains the original plaintext data in a form that is unreadable by a human or computer without the proper decryption key to decrypt it. The computations in homomorphic encryption are performed directly on the encrypted data (ciphertext(s)), which results in encrypted results that match the results of the same computations performed on the original unencrypted plaintext data (with possibly some error due to cryptographic error). Fully Homomorphic encryption (FHE) allows for arbitrary computations on encrypted data, supporting operations such as addition, subtraction, and multiplication operations without limitations on the depth or complexity of the computations.

HE allows users to evaluate any circuit (function) on encrypted data with the following four methods: Gen (generation), Enc (encryption), Dec (decryption), and Eval (evaluation). The client system uses Gen to generate a secret key, a public key, and evaluation keys. The client system stores the secret key and publishes the public key and evaluation keys. Subsequently, an untrusted entity can execute a function with the public key and evaluation keys to evaluate a function on a ciphertext and store the results in another ciphertext. The client then uses Dec to decrypt the results ciphertext.

HE enables computations to be outsourced to untrusted parties while still preserving privacy and confidentiality of the underlying data. Such outsourced computations might include machine learning, secure database queries, and private set intersection algorithms.

Some homomorphic encryption schemes operate on ciphertexts in a single-instruction multiple data (SIMD) fashion wherein a single ciphertext encrypts a fixed-sized vector, and the homomorphic operations on the ciphertext are translated mathematically to operations on the elements in the slots of the plaintext vector.

Multiplication depth in the context of HE refers to the maximum number of sequential multiplications that can be performed on encrypted data before decryption becomes infeasible or bootstrapping is required. Each operation of encrypted data, especially multiplication, increases the noise level of the ciphertext. HE schemes can only handle a certain amount of noise before the bootstrap/decryption result becomes too corrupted to be useful. A common goal in HE models is to decrease the overall multiplication depth.

Standard deep learning models typically comprise a number of layers that perform transformations on input data. Two components in these layers are activation functions and normalizations. Activation functions introduce non-linearities into a deep learning model, which facilitates learning complex patterns of data. Normalization stabilizes and accelerates the training process of the deep learning model.

### SUMMARY

According to an illustrative embodiment parallelizing functions in deep learning models within homomorphic encryption environments is provided. The method comprises arranging layers in a deep learning model architecture. The layers comprise a first layer computed using a sign function and a second layer having components that can be pre-computed or ignored once computing the sign function on the second layer, wherein the first layer and second layer are adjacent within the deep learning model architecture. The deep learning model architecture is trained with a number of hyper-parameters, and the trained deep learning model architecture is run under homomorphic encryption. According to other illustrative embodiments, a computer system and a computer program product for parallelizing functions in deep learning models within homomorphic encryption environments are provided.

### BRIEF DESCRIPTION OF THE DRAWINGS

FIG. 1 is a block diagram of a computing environment in accordance with an illustrative embodiment;

FIG. 2A depicts a diagram illustrating an example of arithmetic computation under homomorphic encryption to which the illustrative embodiments can be applied;

FIG. 2B depicts a diagram illustrating an example of machine learning under homomorphic encryption to which the illustrative embodiments can be applied;

FIG. 3 is a diagram that illustrates a node in a neural network with which illustrative embodiments can be implemented;

FIG. 4 is a diagram illustrating a neural network in which illustrative embodiments can be implemented;

FIG. 5A depicts an example of a standard ConvNeXt block in a neural network;

FIG. 5B depicts a rearranged neural network architecture in accordance with an illustrative embodiment; and

FIG. 6 depicts a flowchart illustrating a method of parallelizing functions in deep learning models within homomorphic encryption environments in accordance with an illustrative embodiment.

### DETAILED DESCRIPTION

According to an illustrative embodiment parallelizing functions in deep learning models within homomorphic encryption environments is provided. The method comprises arranging layers in a deep learning model architecture. The layers comprise a first layer computed using a sign function and a second layer having components that can be pre-computed or ignored once computing the sign function on the second layer, wherein the first layer and second layer are adjacent within the deep learning model architecture. The deep learning model architecture is trained with a number of hyper-parameters, and the trained deep learning model architecture is run under homomorphic encryption. Therefore, the illustrative embodiments provide the technical effect of reducing the contribution of the sign function to computational bottlenecks relative to other functions.

In the illustrative embodiments, when the deep learning model architecture is not a polynomial, the trained deep learning model architecture is converted to polynomial form. Therefore, the illustrative embodiments provide the technical effect of enabling a non-polynomial model to run under homomorphic encryption.

In the illustrative embodiments the first layer comprises an activation function, and the second layer comprises a normalization function. Therefore, the illustrative embodiments provide the technical effect of parallelizing the activation layer and layer normalization.

In the illustrative embodiments, the deep learning model architecture comprises a ConvNeXt architecture for computer vision. Therefore, the illustrative embodiments provide the technical effect of applicability to computer vision.

In the illustrative embodiments, in the case of a ConvNeXt architecture, the activation function is rearranged to apply to layer normalization between an upsampling pointwise layer and a downsampling pointwise layer. Therefore, the illustrative embodiments provide the technical effect of applying the activation to layer normalization after upsampling.

In the illustrative embodiments the components of the second layer that can be mathematically converted to an equivalent function with components that can be reduced under the sign function are ignored. Therefore, the illustrative embodiments provide the technical effect of manipulating the second layer to have some components that can be ignored.

In the illustrative embodiments, the deep learning model architecture comprises a transformer for natural language processing. Therefore, the illustrative embodiments provide the technical effect of applicability to natural language processing.

A computer system comprises a storage device that stores program instructions and one or more processors operably connected to the storage device and configured to execute the program instructions to cause the system to arrange layers in a deep learning model architecture, wherein the layers comprise: a first layer computed using a sign function and a second layer having components that can be pre-computed or ignored once computing the sign function on the second layer, wherein the first layer and second layer are adjacent within the deep learning model architecture; train the deep learning model architecture with a number of hyper-parameters; and run the trained deep learning model architecture under homomorphic encryption. Therefore, the illustrative embodiments provide the technical effect of reducing the contribution of the sign function to computational bottlenecks relative to other functions.

In the illustrative embodiments, when the deep learning model architecture is not a polynomial, the trained deep learning model architecture is converted to polynomial form. Therefore, the illustrative embodiments provide the technical effect of enabling a non-polynomial model to run under homomorphic encryption.

In the illustrative embodiments the first layer comprises an activation function, and the second layer comprises a normalization function. Therefore, the illustrative embodiments provide the technical effect of parallelizing the activation layer and layer normalization.

As part of modifying the deep learning model architecture, activation functions are represented with a sign function or activation functions that use a sign function are searched for. Therefore, the illustrative embodiments provide the technical effect of representing the activation functions with the sign function.

In the illustrative embodiments the deep learning model architecture comprises a ConvNeXt architecture for computer vision. Therefore, the illustrative embodiments provide the technical effect of applicability to computer vision.

In the illustrative embodiments, in the case of a ConvNeXt architecture, the activation function is rearranged to apply to layer normalization between an upsampling pointwise layer and a downsampling pointwise layer. Therefore, the illustrative embodiments provide the technical effect of applying the activation to layer normalization after upsampling.

In the illustrative embodiments the components of the second layer that can be mathematically converted to an equivalent function with components that can be reduced under the sign function are ignored. Therefore, the illustrative embodiments provide the technical effect of manipulating the second layer to have some components that can be ignored.

In the illustrative embodiments, the deep learning model architecture comprises a transformer for natural language processing. Therefore, the illustrative embodiments provide the technical effect of applicability to natural language processing.

A computer program product for parallelizing functions in deep learning models within homomorphic encryption environments. The computer program product comprises a persistent storage medium having program instructions configured to cause one or more processors to arrange layers in a deep learning model architecture, wherein the layers comprise a first layer computed using a sign function and a second layer having components that can be pre-computed or ignored once computing the sign function on the second layer, wherein the first layer and second layer are adjacent within the deep learning model architecture; train the deep learning model architecture with a number of hyper-parameters; and run the trained deep learning model architecture under homomorphic encryption. Therefore, the illustrative embodiments provide the technical effect of reducing the contribution of the sign function to computational bottlenecks relative to other functions.

In the illustrative embodiments, when the deep learning model architecture is not a polynomial, the trained deep learning model architecture is converted to polynomial form. Therefore, the illustrative embodiments provide the technical effect of enabling a non-polynomial model to run under homomorphic encryption.

In the illustrative embodiments the first layer comprises an activation function, and the second layer comprises a normalization function. Therefore, the illustrative embodiments provide the technical effect of parallelizing the activation layer and layer normalization.

In the illustrative embodiments the deep learning model architecture comprises a ConvNeXt architecture for computer vision. Therefore, the illustrative embodiments provide the technical effect of applicability to computer vision.

In the illustrative embodiments the components of the second layer that can be mathematically converted to an equivalent function with components that can be reduced under the sign function are ignored. Therefore, the illustrative embodiments provide the technical effect of manipulating the second layer to have some components that can be ignored.

In the illustrative embodiments, the deep learning model architecture comprises a transformer for natural language processing. Therefore, the illustrative embodiments provide the technical effect of applicability to natural language processing.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

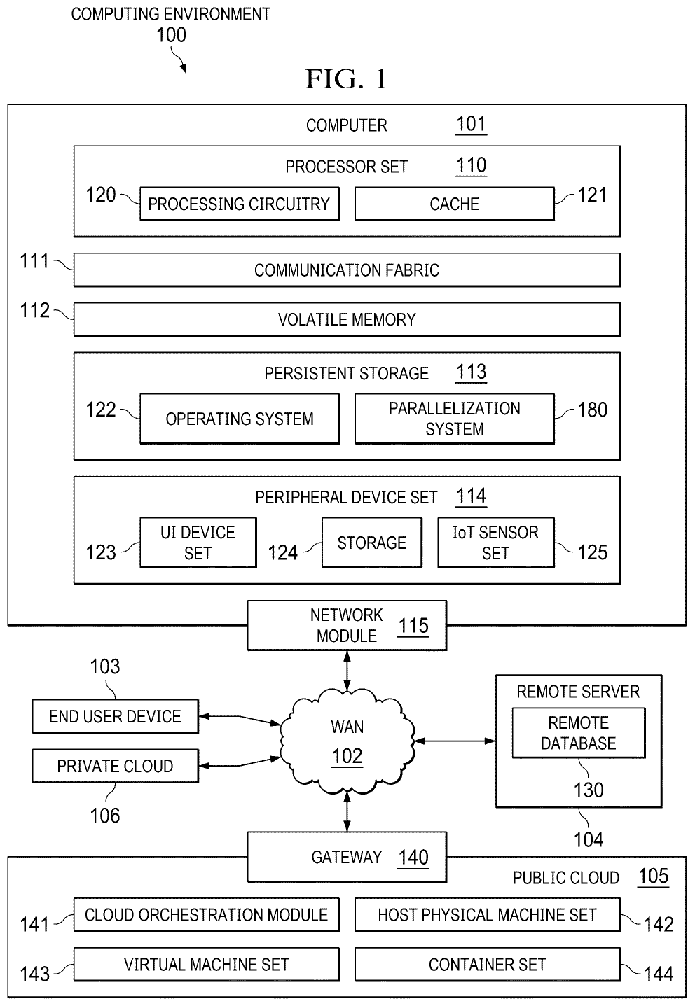

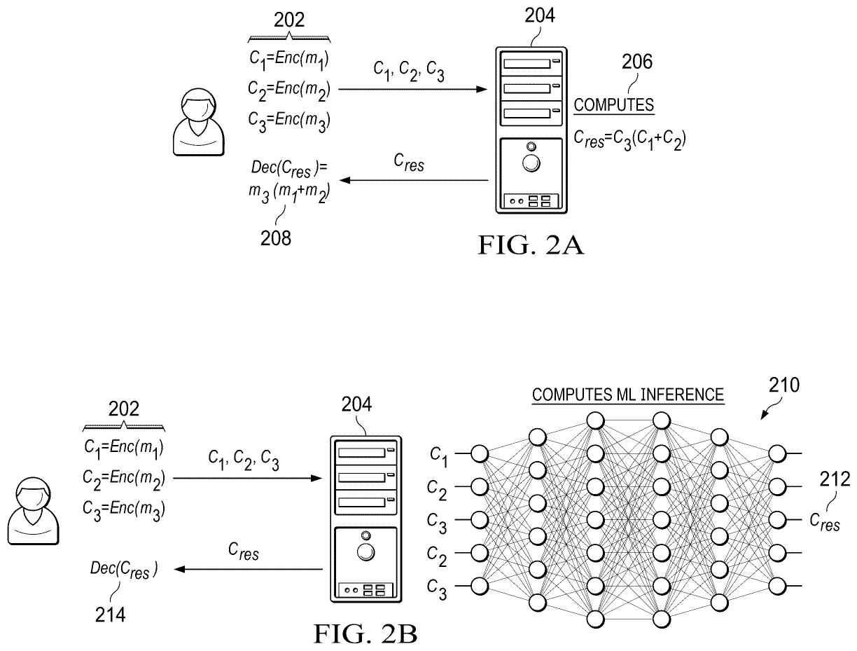

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as parallelization system 180.

In addition to parallelization system 180, computing environment 100 includes, for example, computer 101, wide area network (WAN) 102; end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and parallelization system 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in parallelization system 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in parallelization system 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to a “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 2A depicts a diagram illustrating an example of arithmetic computation under homomorphic encryption to which the illustrative embodiments can be applied. FIG. 2B depicts a diagram illustrating an example of machine learning under homomorphic encryption to which the illustrative embodiments can be applied.

In both examples, a user encrypts data m₁, m₂, m₃ into ciphertexts C₁, C₂, C₃ 202 and then sends the ciphertexts 202 to an untrusted third party such as a cloud system 204 for computation. The examples differ with regard to the nature of the computation performed by the cloud system 204. In FIG. 2A, cloud system 204 performs an arithmetic operation with the encrypted ciphertexts 202 to generate an encrypted result Cᵣₑₛ 206, which is returned to the user. The user can then decrypt the encrypted result 206 to obtain decrypted results Dec(Cᵣₑₛ) 208 which is equivalent to the result that would have been obtained by performing the same arithmetic operation on the original unencrypted data m₁, m₂, m₃.

The example shown in FIG. 2B is a concrete example of computation performed on the ciphertexts C₁, C₂, C₃ 202. In this example, the ciphertexts 202 are fed into the input layer of an artificial neural network 210, which generates a machine learning inference in the form of encrypted result 212 that is returned to the user for decryption to obtain decrypted result Dec(Cᵣₑₛ) 214. Again, the encrypted result 212 generated by neural network 210 is the same as a machine learning inference generated from the original unencrypted data m₁, m₂, m₃.

One of the common functions used by fully homomorphic encryption (FHE) is the sign function, which is defined by:

$$\begin{matrix}sign ( x ) = 1 & when x > 0 \\ sign ( x ) = 0 & when x \leq 0\end{matrix}$$

The sign function is used for comparison. For example, to compare two numbers x and y one can return the value sign (x−y). When x>y, then x−y>0 and sign (x−y)=1, otherwise sign (x−y)=0 as expected.

However, in some FHE schemes, such as CKKS (Cheon-Kim-Kim-Song), an accurate sign function implementation can consume many resources such as latency and memory. Nonetheless, the sign function can be efficiently approximated using the minimax approach. This approach allows for the approximation of non-polynomial functions through a divide and conquer approach. For instance, it approximates the inverse square root function separately for two intervals, while using a polynomial approximation of the sign function to express activation functions like ReLU (rectified linear unit).

The illustrative embodiments reduce both latency and multiplication dept in deep learning models (e.g., neural network 210) operating within HE environments. The illustrative embodiments strategically modify deep learning layer architectures. This modification entails reordering layers to include a term that can be parallelized, capitalizing on the fact that Layer Normalization does not impact the sign of features. This term can be characterized by applying activation after layer normalization. Empirical analysis shows that such reordering has minimal effect on the results in practical applications within the realms of computer vision (CV) and natural language processing (NLP).

For a model employing polynomial activation with a multiplication depth of x, and a normalization layer with a multiplication depth of y, the method of the illustrative embodiments computes both functions with an approximate multiplication depth of max (x,y) instead of x+y, while maintaining the same performance. Additionally, since the computations share resources, it further enhances memory consumption and latency efficiency.

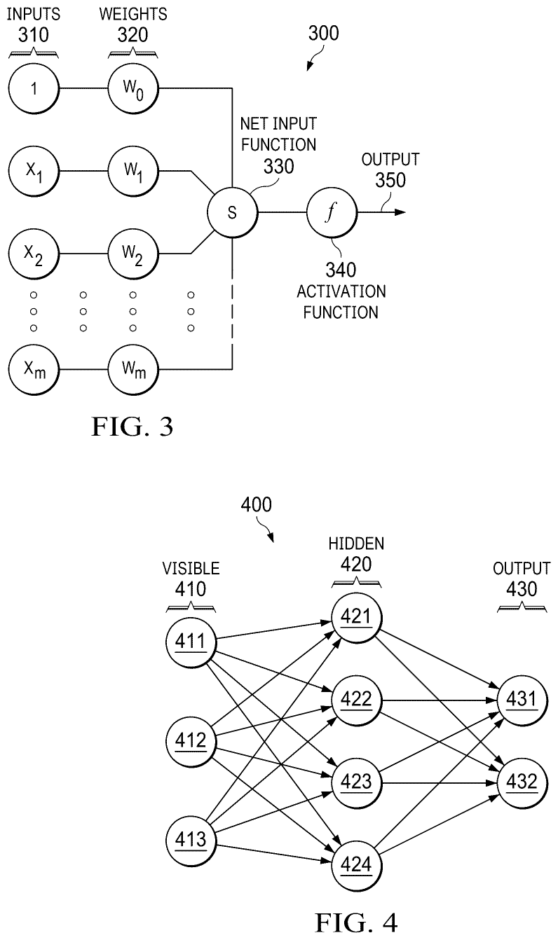

FIG. 3 depicts a diagram illustrating a node in a neural network in which illustrative embodiments can be implemented. Node 300 combines multiple inputs 310 from other nodes. Each input 310 is multiplied by a respective weight 320 that either amplifies or dampens that input, thereby assigning significance to each input for the task the algorithm is trying to learn. The connections between nodes are called edges. When the node 300 receives an input value X, it multiplies X by the weight W assigned to that edge. The net input function 330 adds each X×W (e.g., 1×W₀) product to the bias term b and then passes the result to the activation function 340 which produces the node's output 350. These functions introduce non-linearities into the model, which are essential for learning complex patterns in data. Common activation functions include: ReLU, GeLU (Gaussian Error Linear Unit), SELU (Scaled Exponential Linear Unit), and sigmoid.

The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A layer is a collection of nodes that receives inputs from a previous layer and passes an output to the next layer. Signals travel from the first (input) layer to the last (output) layer, passing through any layers in between. Each layer's output acts as the next layer's input.

FIG. 4 depicts a diagram illustrating a neural network in which illustrative embodiments can be implemented. As shown in FIG. 4, the nodes in the neural network 400 are divided into a layer of input nodes 410, a layer of hidden nodes 420, and a layer of output nodes 430. The nodes in these layers might comprise nodes such as node 300 in FIG. 3. The input nodes 410 are those that receive information from the environment (i.e., a set of external training data). Each input node in layer 410 takes a low-level feature from an item in the dataset and passes it to the hidden nodes in the next layer 420.

In fully connected feed-forward networks, each node in one layer is connected to every node in the next layer. For example, node 421 in hidden layer 420 receives input from all of the input nodes 411, 412, and 413 in input layer 410. Each input value x from the separate nodes 411-413 is multiplied by its respective weight, and all of the products are summed. The result is passed through the activation function to produce output to output nodes 431 and 432 in output layer 430. A similar process is repeated at hidden nodes 422, 423, and 424. In the case of a deeper neural network, the outputs of hidden layer 420 serve as inputs to the next hidden layer.

Artificial neural networks are configured to perform particular tasks by considering examples, generally without task-specific programming. The process of configuring an artificial neural network to perform a particular task may be referred to as training. An artificial neural network that is being trained to perform a particular task may be described as learning to perform the task in question.

In machine learning, the error is calculated via a cost function that estimates how the model is performing. It is a measure of how wrong the model is in terms of its ability to estimate the relationship between input x and output y, which is expressed as a difference or distance between the predicted value and the actual value. The cost function (i.e. loss or error) can be estimated by iteratively running the model to compare estimated predictions against known values of y during supervised learning. The objective of a machine learning model, therefore, is to find parameters, weights, or a structure that minimizes the cost function.

Gradient descent is an optimization algorithm that attempts to find a local or global minima of a function, thereby enabling the model to learn the gradient or direction that the model should take in order to reduce errors. As the model iterates, it gradually converges towards a minimum where further tweaks to the parameters produce little or zero changes in the loss. At this point the model has optimized the weights such that they minimize the cost function.

Neural network layers can be stacked to create deep networks. The activities of its hidden nodes can be used as inputs for a deeper level, thereby allowing stacking of neural network layers. Such stacking makes it possible to efficiently train several layers of hidden nodes. Examples of stacked networks include deep belief networks (DBN), convolutional neural networks (CNN), transformer models, and recurrent neural networks (RNN).

Normalization is crucial for stabilizing and accelerating the training of deep learning models. Layer Normalization is a widely used technique, especially in models like Transformers. The equation for Layer Normalization can be formulated as follows:

$$Layer Norm ( x ) = γ * \frac{( x - μ )}{σ} + β \qquad Eq . 1$$

where “x” represents the input to the layer, μ is the mean of the inputs, σ is the standard deviation of the inputs, γ and β are learnable parameters that scale and shift the normalized input, respectively.

For ease of illustration, the present description focuses on the example of Root Mean Square (RMS) layer normalization, which is very common in deep learning. RMS layer normalization is often used, for example, in transformer-based large language models (LLMs). The equation for RMS layer normalization is expressed as:

$$RMS {NORM ( x )}_{i} = {g}_{i} \frac{{x}_{i}}{\sqrt{( \frac{1}{N} {\sum }_{j = 1}^{N} {x}_{j}^{2} )}} \qquad Eq . 2$$

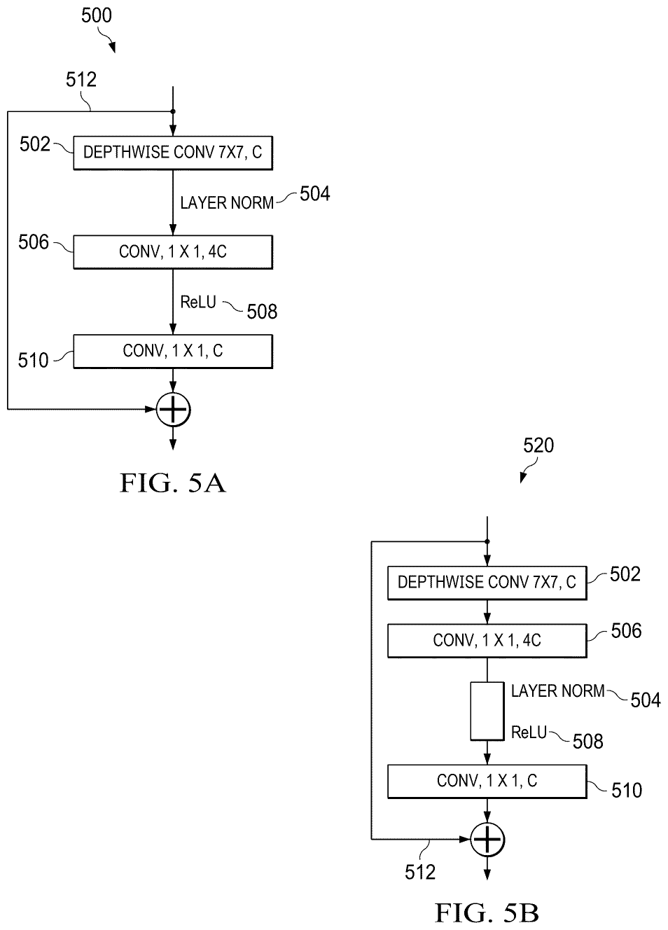

FIGS. 5A and 5B depict an example of rearranging neural network architecture in accordance with an illustrative embodiment. The method of the illustrative embodiments rearranges the architecture of a deep learning neural network such that the layer normalization and neural activation are computed by Activation(LayerNorm(x)) according to Eq. 1. The example shown in FIGS. 5A and 5B demonstrates how to apply the reordering technique of the illustrative embodiments to ConvNeXt, a well-known deep learning model used for feature extraction on datasets in convolutional neural networks (CNNs).

FIG. 5A visualizes a standard ConvNeXt block, which can be formulated as:

$$( ReLU ( conv 1 \times 1 ( normalization ( Conv 7 \times 7 ( x ) ) ) )$$

ConvNeXt block 500 comprises a 7×7 depthwise convolutional layer 502, followed by a layer normalization 504. Layer normalization 504 normalizes the output of depthwise convolutional layer 502 across the features of an individual input.

Layer normalization 504 is followed by a 1×1 (pointwise) convolutional layer 506 that upsamples the feature map by a factor of four. Another 1×1 convolutional layer 510 downsamples the feature map count back to what it was upon entering ConvNeXt block 500, which allows a skip connection 512 to be made at the end. Skip connection 512 allows the original input to be added directly to the output of the final convolutional layer 506. ReLU activation function 508 is between the two pointwise convolutional layers 506 and 510.

FIG. 5B illustrates a rearranged ConvNeXt block in accordance with an illustrative embodiment. The rearrangement modifies the ConvNeXt block 500 shown in FIG. 5A by placing the layer normalization 504 after the first pointwise convolutional layer 506 and applying ReLU activation function 508 to the normalization:

$$( Activation ( layer Norm ( x ) ) ) .$$

Therefore, rearranged ConvNeXt block 520 can be formulated as:

$$( ReLU ( normalization ( conv 1 \times 1 ( Conv 7 \times 7 ( x ) ) ) ) )$$

This formulation included Eq. 1, which can be optimized.

Empirical analysis demonstrates that training such rearranged deep learning model from scratch using the same hyper-parameters achieves the same performance in practical applications such as, for example, ConvNeXt for computer vision and transformers for NLP applications. Notably, for transformers, this architectural modification does not negatively affect the model's performance (up to a negligible 0.2%, which can be further reduced with additional training).

Many activation functions in HE are computed via the sign function. Notable examples include ReLU, GeLU, SELU, and Leaky ReLU. However, the sign function is the primary computational bottleneck. Rearranging the neural network architecture reduces the contribution of the sign function to computational bottlenecks relative to other functions.

The activation can be expressed as activation(z)=f(sign (z), z) for some variable z. Therefore, Equation 1 can be reformulated as:

$$f ( sign ( Layer Norm ( x ) ) , Layer Norm ( x ) )$$

where x is a vector x=(x₁, x₂, . . . , x_{N}). The activation function, denoted Act(x), is applied to vector x element-wise such that:

$$Act ( X ) = ( Act ( {x}_{1} ) , Act ( {x}_{2} ) , … , Act ( {x}_{N} ) )$$

Therefore, the activation function operates independently on each coordinate of the vector x.

Breaking down this term per coordinate yields:

$$\begin{matrix}Act ( {RMSNorm ( x )}_{i} ) = f ( Sign ( {RMSNorm ( x )}_{i} ) , {RMSNorm ( x )}_{i} ) \\ = f ( Sign ( {g}_{i} \frac{{x}_{i}}{\sqrt{\frac{1}{N} {\sum }_{j = 1}^{N} {x}_{j}^{2}}} ) , {g}_{i} \frac{{x}_{i}}{\sqrt{\frac{1}{N} {\sum }_{j = 1}^{N} {x}_{j}^{2}}} \\ From Sign ( xy ) = Sign ( x ) * Sign ( y ) we get \\ = f ( Sign ( {g}_{i} ) Sign ( {x}_{i} ) Sign ( \frac{1}{\sqrt{\frac{1}{N} {\sum }_{j = 1}^{N} {x}_{j}^{2}}} ) , \frac{{g}_{i} {x}_{i}}{\sqrt{\frac{1}{N} {\sum }_{j = 1}^{N} {x}_{j}^{2}}} )\end{matrix} \qquad Eq . 3$$

But

$$\sqrt{\frac{1}{N} {\sum }_{j = 1}^{N} {x}_{j}^{2}}$$

is always positive so that

$$Sign ( \sqrt{\frac{1}{N} {\sum }_{j = 1}^{N} {x}_{j}^{2}} ) = 1$$

and gᵢ is constant c₀ at inference

$$= f ( {c}_{90} Sign ( {x}_{i} ) , \frac{{g}_{i}}{\sqrt{\frac{1}{N}}} {x}_{i} \frac{1}{\sqrt{{\sum }_{j = 1}^{N} {x}_{j}^{2}}} )$$

We can compute Sign (xᵢ) in parallel with

$$\frac{1}{\sqrt{{\sum }_{j = 1}^{N} {x}_{j}^{2}}}$$

$$h ( y ) = \frac{1}{\sqrt{y}}$$

can be computed using Sign functions, i.e.,

$$\begin{matrix}h ( y ) = \frac{1}{\sqrt{y}} = {p}_{4} ( Sign ( {p}_{1} ( y ) ) {p}_{2} ( y ) + ( 1 - Sign ( {p}_{1} ( y ) ) {p}_{3} ( y ) ) \\ = {p}_{4} ( {p}_{3} ( y ) + Sign ( {p}_{1} ( y ) ) ( {p}_{2} ( y ) - {p}_{3} ( y ) ) )\end{matrix}$$

Both sign functions can now be computed in parallel, reducing memory consumption, multiplication depth and latency. This method reduces the number of iterations required for convergence by almost half.

The method of illustrative embodiments can be applied to modifying existing deep neural networks as well as creating and designing new networks from scratch. For example, in an existing network, there might ne a sequence of layers A(B(C(x))) acting on some input x, where the layer A is computed under FHE using the Sign function. The layer C has some components that can be precomputed/ignored once computing a Sign function on C. These layers can be rearragned into B(A(C(x)))) or A(C(B(x))) in order to place A and C adjacent to each other. Note that here, B can be one layer or multiple layers, depending on the context. For example, A might comprise activation, B might comprise matrix multiplication or conv2D, and C comprises normalization.

In the case of a new neural network with the goal of running it as an FHE application, the designer can place A after C, i.e. A(C(x)), during the initial design phase.

In both cases, a deep neural network may have several group of layers A,B,C or A,C.

Examples of components in layer C that can be precomputed/ignored once computing a Sign function on C include Sqrt(x) (always positive), Log (x)>1 (always positive), Log (x)<1 (always negative), polynomial^{∧}(even positive integer power) (always positive).

For example, if

$$C = {( x + y )}^{*} sqrt ( x ) * ( x \hat{} 3 + 5 ) \hat{} 2$$

then

sign (c)=sign ((x+y)*sign (sqrt(x))*sign ((x^{∧}3+5)^{∧}2))=sign (x+y) because sign (sqrt(x))=1 and sign ((x^{∧}3+5)^{∧}2)=1.

Some functions such as C can be manipulated to have some components that can be ignored. For example, if C=x^{∧}2+2xy+y^{∧}2 then sign (C)=sign (x^{∧}2+2xy+y^{∧}2) must be computed as is, i.e., no components can be ignored. However, it is easy to see that x^{∧}2+2xy+y^{∧}2=(x+y)^{∧}2 and thus sign (C)=1 by definition. In a broader sense, C has components that can be ignored if it can be converted mathematically to an equivalent function with components that can be reduced under Sign.

If the deep neural network is not polynomial, it needs to be transformed into polynomial form in order to run under FHE. This transformation can be done offline in advance or after several training epochs online.

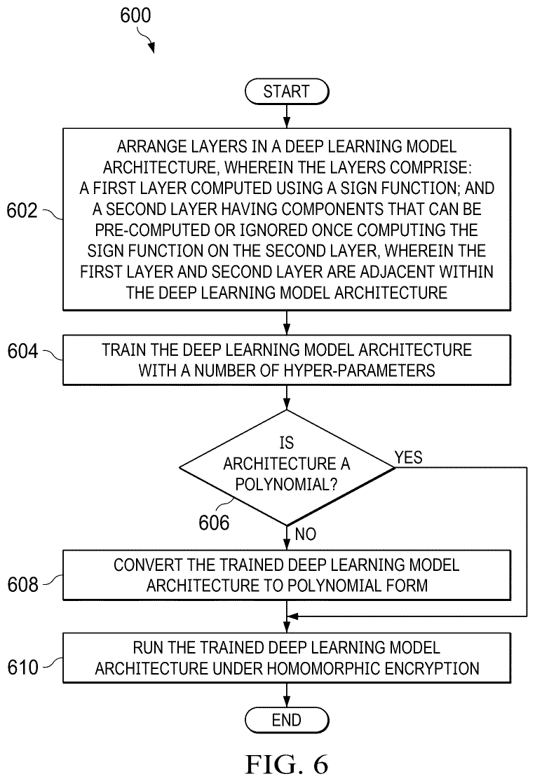

FIG. 6 depicts a flowchart illustrating a method of parallelizing functions in deep learning models within homomorphic encryption environments in accordance with an illustrative embodiment. Process 600 can be performed by parallelization system 180 in FIG. 1.

Process 600 begins by arranging layers in a deep learning model architecture, wherein the layers comprise a first layer computed using a sign function and a second layer having components that can be pre-computed or ignored once computing the sign function on the second layer, wherein the first layer and second layer are adjacent within the deep learning model architecture (step 602). Components of the second layer that can be mathematically converted to an equivalent function with components that can be reduced under the sign function are ignored.

The first layer might comprise an activation function, and the second layer might comprise a normalization function. The deep learning model architecture might comprise a ConvNeXt architecture for computer vision or a transformer for natural language processing. In the case of a ConvNeXt architecture, the activation function is rearranged to apply to layer normalization between an upsampling pointwise layer and a downsampling pointwise layer.

Process 600 then trains the deep learning model architecture with a number of hyper-parameters (step 604).

The deep learning model architecture may or may not be a polynomial (step 606). If the deep learning model architecture is not a polynomial, process 600 converts the trained modified deep learning model architecture to polynomial form (step 608). The present example shows the conversion performed after training, but it should be noted that conversion to polynomial form can be performed before, during, or, after training the model.

Process 600 runs the trained deep learning model architecture under homomorphic encryption (step 610). Process 600 then ends.

As used herein, “a number of” when used with reference to items, means one or more items. For example, “a number of parameters” is one or more parameters. As another example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method of parallelizing functions in deep learning models within homomorphic encryption environments, the method comprising:
arranging layers in a deep learning model architecture, wherein the layers comprise:
a first layer computed using a sign function; and
a second layer having components that can be pre-computed or ignored once computing the sign function on the second layer, wherein the first layer and second layer are adjacent within the deep learning model architecture;
training the deep learning model architecture with a number of hyper-parameters; and
running the trained deep learning model architecture under homomorphic encryption.

2. The method of claim 1, further comprising converting the trained deep learning model architecture to polynomial form.

3. The method of claim 1, wherein:
the first layer comprises an activation function; and
the second layer comprises a normalization function.

4. The method of claim 3, wherein the deep learning model architecture comprises a ConvNeXt architecture for computer vision.

5. The method of claim 4, wherein the activation function is rearranged to apply to layer normalization between an upsampling pointwise layer and a downsampling pointwise layer.

6. The method of claim 1, wherein the components of the second layer that can be mathematically converted to an equivalent function with components that can be reduced under the sign function are ignored.

7. The method of claim 1, wherein the deep learning model architecture comprises a transformer for natural language processing.

8. A system for parallelizing functions in deep learning models within homomorphic encryption environments, the system comprising:
a storage device that stores program instructions;
one or more processors operably connected to the storage device and configured to execute the program instructions to cause the system to:
arrange layers in a deep learning model architecture, wherein the layers comprise:
a first layer computed using a sign function; and
a second layer having components that can be pre-computed or ignored once computing the sign function on the second layer, wherein the first layer and second layer are adjacent within the deep learning model architecture;
train the deep learning model architecture with a number of hyper-parameters; and
run the trained deep learning model architecture under homomorphic encryption.

9. The system of claim 8, wherein the program instructions further cause the system to convert the trained deep learning model architecture to polynomial form.

10. The system of claim 8, wherein:
the first layer comprises an activation function; and
the second layer comprises a normalization function.

11. The system of claim 10, wherein the deep learning model architecture comprises a ConvNeXt architecture for computer vision.

12. The system of claim 11, wherein the activation function is rearranged to apply to layer normalization between an upsampling pointwise layer and a downsampling pointwise layer.

13. The system of claim 12, wherein the components of the second layer that can be mathematically converted to an equivalent function with components that can be reduced under the sign function are ignored.

14. The system of claim 8, wherein the deep learning model architecture comprises a transformer for natural language processing.

15. A computer program product for parallelizing functions in deep learning models within homomorphic encryption environments, the computer program product comprising:
a persistent storage medium having program instructions configured to cause one or more processors to:
arrange layers in a deep learning model architecture, wherein the layers comprise:
a first layer computed using a sign function; and
a second layer having components that can be pre-computed or ignored once computing the sign function on the second layer, wherein the first layer and second layer are adjacent within the deep learning model architecture;
train the deep learning model architecture with a number of hyper-parameters; and
run the trained deep learning model architecture under homomorphic encryption.

16. The computer program product of claim 15, further comprising instructions to convert the trained deep learning model architecture to polynomial.

17. The computer program product of claim 15, wherein:
the first layer comprises an activation function; and
the second layer comprises a normalization function.

18. The computer program product of claim 17, wherein the deep learning model architecture comprises a ConvNeXt architecture for computer vision.

19. The computer program product of claim 15, wherein the components of the second layer that can be mathematically converted to an equivalent function with components that can be reduced under the sign function are ignored.

20. The computer program product of claim 15, wherein the deep learning model architecture comprises a transformer for natural language processing.
